(19) United States
(12) Patent Application Publication
(10) Pub. No.: US 2026/0094480 A1
(43) Pub. Date: Apr. 2, 2026

(54) PHYSICALLY SECURING PASSIVE DEVICES WITH SMART PHONES

(71) Applicant: Huawei Technologies Co., Ltd., Shenzhen (CN)

(72) Inventor: Peter James Ashwood-Smith, Gatineau (CA)

(21) Appl. No.: 19/410,581

(22) Filed: Dec. 5, 2025

Related U.S. Application Data
(63) Continuation of application No. PCT/CN2023/113436, filed on Aug. 17, 2023.

(51) Int. Cl. G07C 9/00; E05B 49/00

(52) U.S. Cl. CPC G07C 9/00182; E05B 49/004; G07C 2009/00785

(57) ABSTRACT

Passive lock assemblies that can be locked and unlocked by a mobile device are disclosed. Embodiments may include a lock assembly that includes an optical-to-electrical converter device, a key reader, and a processor. The optical-to-electrical converter device is configured to generate an electrical signal when illuminated by light produced by a mobile device. The key reader is configured to be powered by the electrical signal and, when powered, to read a key encoded in the light and to generate a key signal in accordance with the key. The processor is configured to be powered by the electrical signal and, when powered, receive the key signal and determine a validity of the key in accordance with the key signal. The processor is further configured to, when powered and the key is valid, generate a switch signal.

### CROSS-REFERENCE TO RELATED APPLICATION

The present application is a continuation of Patent Cooperation Treaty Application Serial No. PCT/CN2023/113436, entitled “PHYSICALLY SECURING PASSIVE DEVICES WITH SMART PHONES,” filed on August 17, 2023, the entirety of which is incorporated by reference herein.

### TECHNICAL FIELD

The present disclosure generally relates to security technologies, and more particularly methods and apparatus for using mobile devices as keys.

### BACKGROUND

Smart locks use electronics to provide security and to controllably restrict user access. Such locks typically include electronic circuitry and components that can receive a key signal. Unlike wholly mechanical locks, which are opened with a physical key, smart locks may be opened with an electromagnetic prompt. Examples of keys for smart locks include radio-frequency identification tags, codes entered by electronic keypads, Bluetooth or Wi-Fi signals from smart phones, and magnetic strip or chip cards. Once the electronic signal or code from the key is received by the smart lock, an internal power source opens the lock. For locks restricting physical access, such as those on doors, the power source could energize an electromechanical mechanism to retract a latch bolt or dead bolt. For locks other than those restricting physical access, the power source may release (unlock) secure information to the keyholder.

To ensure continuous and reliable operation, the power source in a smart lock must be periodically replaced or recharged. Typically, this involves changing one or more batteries that power the lock. However, batteries can be vulnerable to environmental factors, such as cold temperatures, which can impair their ability to supply power. Smart locks powered by an electrical distribution grid may be similarly susceptible to power outages in the grid. If a battery, or other power source, fails to supply power to the smart lock, a keyholder can find themselves unexpectedly locked out, e.g., from a physical location or from accessing secured information.

Therefore, improvements in smart locks are desirable.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present disclosure is to provide improvements in smart locks.

A first aspect of the present disclosure is to provide a lock assembly comprising circuitry and a locking device coupled to the circuitry. The circuitry may have: an optical-to-electrical converter device configured to generate an electrical signal when illuminated by light produced by a mobile device; a key reader to be powered by the electrical signal and, when powered, to read a key encoded in light produced by the mobile device and to generate a key signal in accordance with the key; and a processing unit configured to be powered by the electrical signal and, when powered, receive the key signal and determine a validity of the key in accordance with the key signal. The processing unit may be further configured to, when powered and the key is valid, generate a switch signal. The locking device may be configured to be powered by the electrical signal and to switch between a locked configuration and an unlocked configuration. The locking device may be further configured to, when powered, receive the switch signal and, when the switch signal is received, switch from the locked configuration to the unlocked configuration. In some embodiments, the locking device may still further be configured to, when the key is valid, generate another switch signal to switch the lock assembly from the unlocked configuration to the locked configuration.

In some embodiments of the first aspect, the lock assembly may further comprise a housing defining a recess configured to receive the mobile device. In some embodiments, the optical-to-electrical converter device and the key reader may be located in the recess. In some embodiments, the lock assembly may further comprise a latch mechanism configured to be actuated by a predetermined movement of the mobile device when the mobile device is in the recess. In these embodiments, the locking device may be an electromechanical lock configured to hold the latch mechanism when in the locked configuration and to release the latch mechanism when in the unlocked configuration. In some embodiments, the housing may have a lock identifier. The lock identifier may be an image, which may further be a barcode or a QR code.

In some embodiments of the first aspect, the lock assembly may further comprise a latch mechanism to be actuated by a predetermined movement of a handle mechanically coupled to the latch mechanism. In these embodiments, the locking device may be an electromechanical lock configured to hold the latch mechanism when in the locked configuration and to release the lock mechanism when in the unlocked configuration.

In some embodiments of the first aspect, the locking device may be an electromechanical lock having a bolt configured to be in an extended position when in the locked configuration and to be in a retracted position when in the unlocked configuration.

In some embodiments of the first aspect wherein the locking device may be an electromechanical lock, the circuitry may include a solenoid or a motor to switch the electromechanical lock between the locked configuration and the unlocked configuration.

In some embodiments of the first aspect, the locking device may have a sensor coupled to a transmitter. The sensor may be configured to, when powered, collect data. The transmitter may be configured to, when powered and in the unlocked configuration, obtain the data collected from the sensor and send the data to the mobile device. In some embodiments, the transmitter may send the data to the mobile device through wireless radio communication or through light.

In some embodiments of the first aspect, the circuitry may have memory configured to store data thereon. In these embodiments, the locking device may be an electronic display configured to, when powered and in the unlocked configuration, obtain the data stored on the memory and display the data. In some embodiments, the electronic display may be an electronic paper display.

In some embodiments of the first aspect, the key may be encoded in the light produced by the mobile device as one or more changes in one or more optical properties of the light over a period of time. The one or more optical properties of the light may include at least one of a polarization of the light, a phase of the light, a frequency of the light, and an intensity of the light. In some of these embodiments, the key reader may include a photodetector. In some other embodiments, the key may be encoded in the light produced by the mobile device as a spatial pattern of at least one of light intensity and color. In some of these embodiments, the key reader may be an image sensor.

In some embodiments of the first aspect, the optical-to-electrical converter device may include a photovoltaic cell. In some embodiments, the photovoltaic cell may be a thermophotovoltaic cell.

In some embodiments of the first aspect, the optical-to-electrical converter device may be coupled to the processing unit and to an electrical energy storage device. In some embodiments, the electrical energy storage device may include at least one of a battery and a capacitor.

In some embodiments of the first aspect, the key signal may be a binary code.

In some embodiments of the first aspect, the lock assembly may further comprise a lock light source configured to be powered by the electrical signal and, when powered, emit light encoded with a lock identifier.

A second aspect of the present disclosure is to provide methods for unlocking the lock assembly of the first aspect and any variants thereof. In some embodiments, the method may comprise producing, by the mobile device, the light, and encoding, by the mobile device, the key in the light produced by the mobile device. In some embodiments wherein the lock assembly comprises a housing having a lock identifier, the method may further comprise reading, by the mobile device, the lock identifier and determining, by the mobile device, the key according to the lock identifier. In some embodiments wherein the lock assembly comprises a lock light source, the method may further comprise receiving, by the mobile device, the light encoded with the lock identifier and determining, by the mobile device, the key according to the lock identifier. In some embodiments wherein the lock assembly comprises a housing defining a recess configured to receive the mobile device and a latch mechanism configured to be actuated by a predetermined movement of the mobile device when the mobile device is in the recess, the method may further comprise inserting the mobile device into the housing and moving the mobile device according to the predetermined movement. In some other embodiments, the method may comprise producing, by one or more light sources of a casing of the mobile device, the light and encoding, by the one or more light sources of the casing of the mobile device, the key in the light produced by the one or more light sources of the casing of the mobile device. In some of these embodiments wherein the lock assembly comprises a lock light source, the method may further comprise receiving, by a light detector of the casing of the mobile device, the light encoded with the lock identifier and encoding, by the one or more light sources of the casing of the mobile device, the key in the light produced by the one or more light sources of the casing of the mobile device in accordance with the lock identifier.

A third aspect of the present disclosure is to provide an apparatus comprising means to perform the method shown above.

A third aspect of the present disclosure is to provide a non-transitory computer-readable medium storing instructions, when the instructions executed by a computer, cause the computer to perform the method shown above.

Embodiments have been described above in conjunction with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

FIG. 1 shows a schematic for a passive lock assembly that can be powered and unlocked by a mobile device, according to embodiments of the present disclosure.

FIG. 2 shows a schematic for a passive lock assembly that can be powered by a mobile device and unlocked using the mobile device’s display, according to embodiments of the present disclosure.

FIG. 3 shows a schematic for a passive lock assembly with an electronic display that can be powered and unlocked using a mobile device, according to embodiments of the present disclosure.

FIG. 4 shows a schematic for a passive lock assembly with a data sensor that can be powered and unlocked using a mobile device, according to embodiments of the present disclosure.

FIG. 5 shows a schematic for a passive lock assembly that when powered by a mobile device can communicate a lock identifier to the mobile device, according to embodiments of the present disclosure.

FIG. 6 shows a schematic for a passive lock assembly that can be powered and unlocked by a mobile device case, according to embodiments of the present disclosure.

FIG. 7 shows a passive lock assembly with a latch mechanism that can be opened by a predetermined movement of a mobile device, according to embodiments of the present disclosure.

FIG. 8 shows a passive lock assembly with a lock identifier, according to embodiments of the present disclosure.

FIG. 9 shows a flowchart of a method for unlocking passive lock assemblies, according to embodiments of the present disclosure.

FIG. 10 shows an apparatus for implementing methods of the present disclosure.

FIG. 11 shows a schematic of an embodiment of an electronic device that may implement at least part of the methods and features of the present disclosure.

### DETAILED DESCRIPTION OF THE ILLUSTRATIVE EMBODIMENTS

Embodiments of the present disclosure are generally directed towards providing lock assemblies that can be powered and unlocked using light generated by a mobile device. Because power may be delivered to the lock assembly from an external source (i.e., a mobile device), the lock assemblies of the present disclosure may be considered “passive”. In some embodiments a key may be encoded in the light generated by the mobile device and read by the lock assembly. When a valid key is provided by the mobile device, the lock assembly may switch from a locked configuration to an unlocked configuration. In some embodiments the switch between configurations may release a latch or a bolt that physically restricts user access to a physical space. In these embodiments the mobile device may further be used to retract or extend the latch or bolt by moving the mobile device in a housing of the lock assembly according to a predetermined movement, such as a rotation of the mobile device. In some embodiments the switch between configurations may cause data to be displayed on an electronic display. In some other embodiments the switch may cause data to be transmitted to the mobile device. The present disclosure also provides for methods for locking and unlocking the passive lock assemblies.

The present disclosure sets forth various embodiments via the use of block diagrams, flowcharts, and examples. Insofar as such block diagrams, flowcharts, and examples contain one or more functions and/or operations, it will be understood by a person skilled in the art that each function and/or operation within such block diagrams, flowcharts, and examples can be implemented, individually or collectively, by a wide range of hardware, software, firmware, or combination thereof. The terms in each of the following sets may be used interchangeably throughout the disclosure: “latch”, “latch mechanism”, and “bolt”; “key reader” and “image sensor”; and “case” and “casing”.

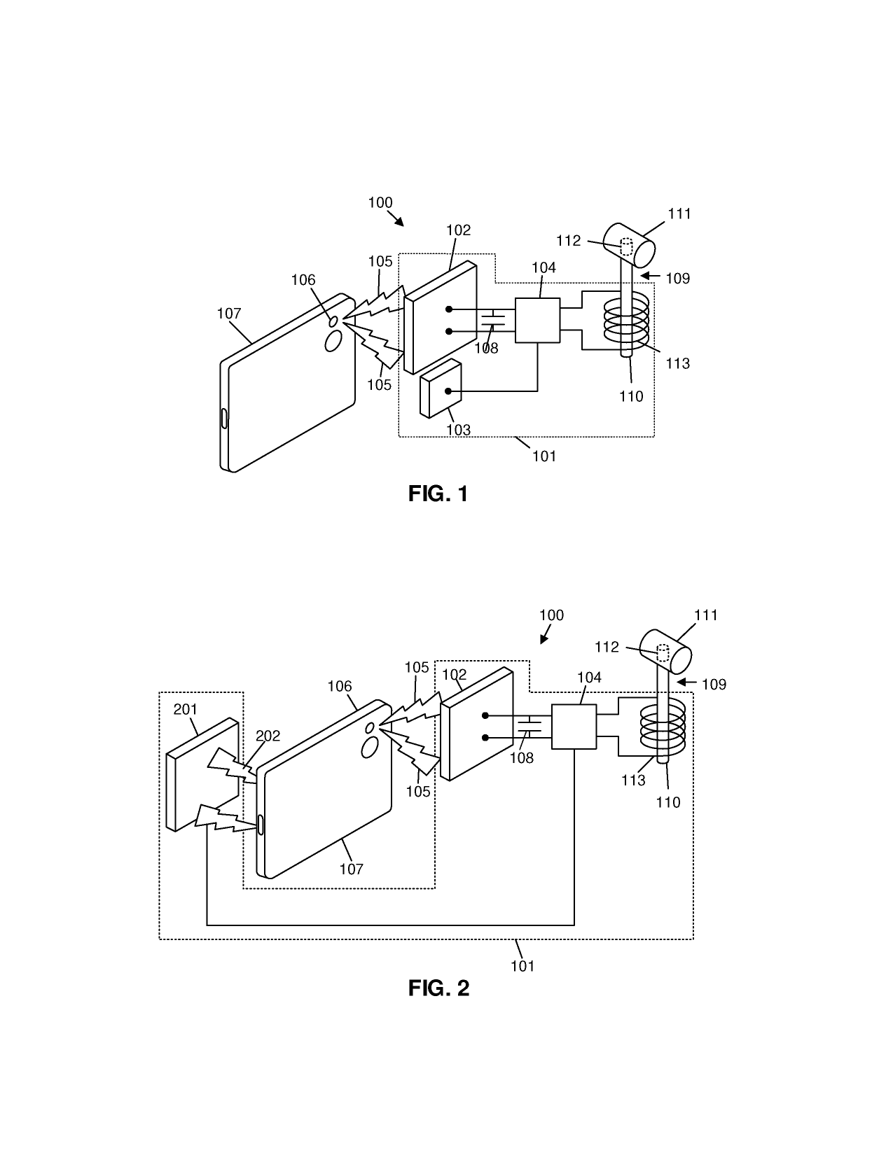

FIG. 1 shows a schematic for a passive lock assembly 100, according to an embodiment of the present disclosure. The lock assembly 100 may have circuitry 101 comprising an optical-to-electrical converter device 102 (e.g., a photovoltaic cell, a thermophotovoltaic cell, etc.), a key reader 103, and a processing unit 104. The optical-to-electrical converter device 102 may be configured to receive light 105 from a light source 106 of a mobile device 107 and, when illuminated with such light 105, may generate an electrical signal. The electrical signal may then power the circuitry 101, including the key reader 103 and processing unit 104, and any other components of the lock assembly 100. Each component of the lock assembly 100 may be coupled to other components through, for example, electrical wires or inductive elements. The optical-to-electrical converter device 102 may be coupled to remaining components of the circuitry 101 through or in parallel with an electrical energy storage device 108, which may store and dispense electrical energy generated by the optical-to-electrical converter device 102. Although the energy storage device 108 is depicted as a capacitor element in FIG. 1, in some embodiments, it may also be a battery element or may be absent. The key reader 103 may be configured to, when powered by the electrical signal, receive light 105 from the light source 106 of the mobile device and translate a key encoded in the light 105 into a key signal. The key signal may be conveyed to the processing unit 104 as, for example, another electrical signal. Upon receiving a key signal, the processing unit 104 may determine whether the key is valid. If the key is determined to be valid, the processing unit 104 may generate a switch signal to switch the lock assembly 100 from a locked configuration to an unlocked configuration, or another switch signal to switch the lock assembly 100 from an unlocked configuration to a locked configuration. A switch signal may then affect a switch of the lock assembly 100 between the locked configuration and the unlocked configuration through a locking device 109. The locking device 109 may also be powered by the electrical signal generated by the optical-to-electrical converter device 102.

The locking device 109 is depicted in FIG. 1 as an electromechanical lock in which a pin 110 mechanically holds a bolt 111. The pin 110 may be extended, when switching to the locked configuration, into a recess 112 of the bolt 111 to hold it or may be retracted, when switching to the unlocked configuration, from the recess 112 to release the bolt 111. The pin 110 may be extended or retracted by the action of an electromotive force associated with the switch signal on, for example, a solenoid 113 (as depicted) or a motor. Alternatively, the bolt 111 itself may be extended or retracted in switching between the locked and unlocked configurations by a solenoid 113 or a motor responding to the switch signal. The bolt 111 may, for example, be a latch (i.e., a “latch mechanism”) or a deadbolt. In some embodiments, such as a lock assembly for a door, the bolt may be configured to extend into a recess of a strike plate to secure the lock assembly to the strike plate. In some embodiments having a latch, the latch may be actuated to retract by a handle mechanically coupled to the latch when the handle is moved according to a predetermined movement. The handle may, for example, be a doorknob or a push bar. The locking device 109 may be a device other than an electromechanical lock, as discussed in relation to other embodiments hereinbelow.

The mobile device 107 may be any electronic device that can generate light 105 and encode a key in the light 105. Examples of a mobile device 107 may include a cellular or smart phone, a tablet, and a smart watch. The light source 106 may be, for example, a flashlight, a camera flash, a display screen, a laser, or a light emitting diode. In addition, the light source 106 may be one of the aforementioned sources or may comprise a plurality of these sources. The light 105 may have associated thereto a spectrum of wavelengths that is broad or narrow. For example, the light 105 may be a white light or a monochromatic light. Wavelengths associated with the light 105 may, for example, belong to ultraviolet, visible, and/or infrared regions. A key may be encoded in the light 105 by, for example, temporally and/or spatially modulating (changing) one or more optical properties of the light, which may include, for example, a polarization, a phase, a frequency, and/or an intensity of the light 105.

The optical-to-electrical converter device 102 may be any device that can convert electromagnetic energy associated with the light 105 to electric potential energy to generate an electrical signal. The optical-to-electrical converter device 102 may be a module or panel comprising one or a plurality of individual photovoltaic cells. The optical-to-electrical converter device 102 may be configured to have an absorption spectrum that overlaps with the spectrum of the light 105. The light 105 may be converted to electric potential energy through, for example, a photovoltaic effect, a thermophotovoltaic effect, or a photoelectrochemical effect.

The key reader 103 may be any device that can convert a key encoded in the light 105 into a key signal, which may be in the form of an electrical signal. The key reader 103 may, for example, be a photodetector such as a photodiode, or an image sensor such as a charge-coupled device or complimentary-metal-oxide semiconductor sensor. The key reader 103 may, for example, operate through a photoconductive, photoelectric, photothermal, or photochemical effect. The key signal may contain the key information as a digital or analog signal.

The processing unit 104 may include one or more microprocessors. It may also include additional electronic components such as memory, a signal amplifier, an analog-to-digital converter, a digital-to-analog converter, a signal processor (filter), an analog or digital application-specific integrated circuit (ASIC), or other discrete analog or digital components.

There may be a single valid key or a plurality of valid keys for the lock assembly 100. Each key may be encoded in the light 105 as a unique pattern or signal. Each key may be generated according to any suitable cryptographic algorithm. Alternatively, the lock assembly may have a fixed number of predetermined valid keys. The validity of a key may be determined through a one-to-one comparison with data stored in the processing unit 104 or according to a cryptographic algorithm programmed in the processing unit 104. In other embodiments, a next valid key of the predetermined keys may be selected based on the previous valid key.

FIG. 2 shows a schematic for a passive lock assembly 100, according to an embodiment of the present disclosure, where the key reader 104 is an image sensor 201 configured to receive the key as encoded light 202 generated by a display of the mobile device 107. In this embodiment, the key may be a spatial pattern of light 202 emitted from the display of the mobile device 107, such as a one- or two-dimensional barcode or a particular image. The spatial pattern of light 202 may be black and white or may incorporate a combination of colors. The image sensor 201 may be an array of photodetector elements that can convert a spatial pattern of light 202 into a key signal.

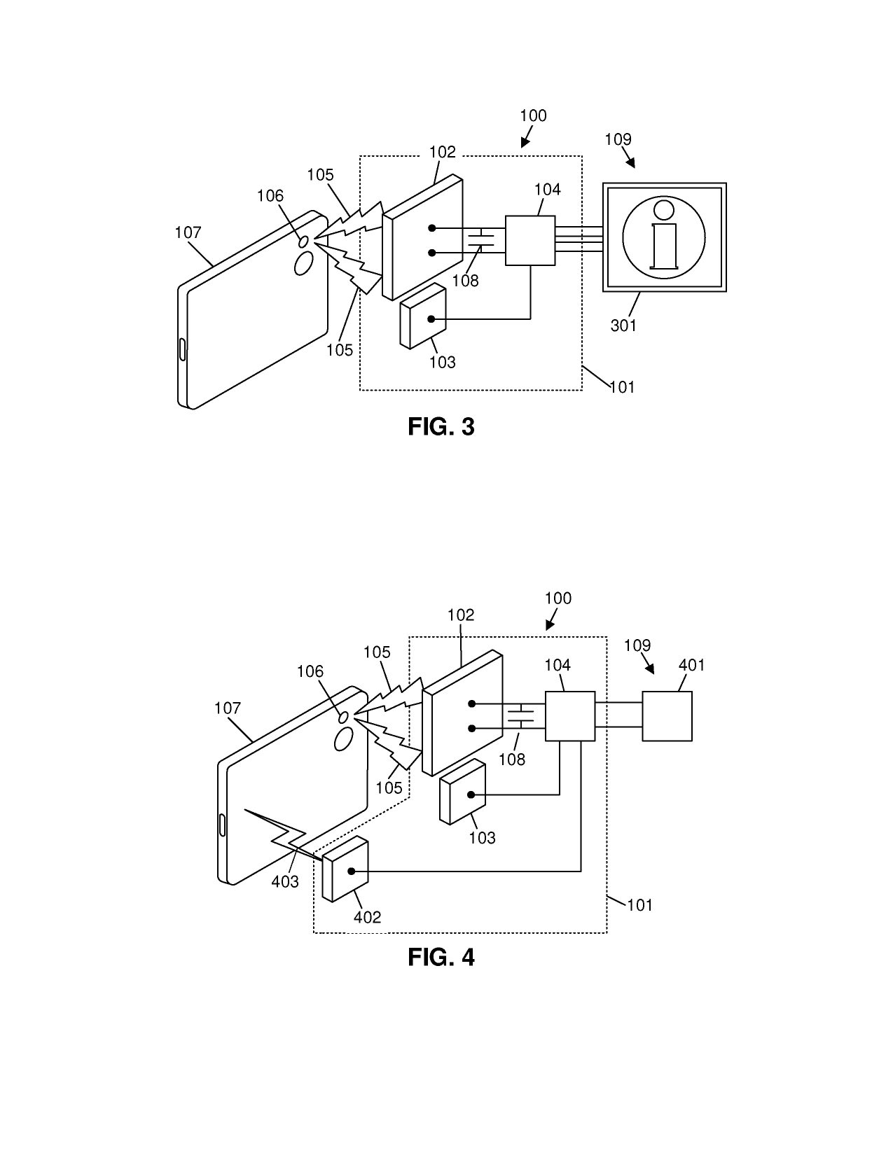

FIG. 3 shows a schematic for a passive lock assembly 100, according to an embodiment of the present disclosure, where the locking device 109 is an electronic display 301. In this embodiment, when the switch signal switches the lock assembly 100 to an unlocked configuration, the electronic display 301 may display information, which may be stored on memory associated with the processing unit 104 or the electronic display 301. The electronic display 104 may, for example, be an electronic paper display, a light emitting diode display, or a liquid-crystal display. The information that is displayed may, for example, be an image, text, or video. When the switch signal switches the lock assembly 100 to a locked configuration, the electronic display 301 may remove the displayed information. In some embodiments, when the switch signal switches the lock assembly 100 to an unlocked configuration, the electronic display 301 may display different information than the information that was displayed in the locked configuration. In some embodiments, when the switch signal switches the lock assembly 100 to an unlocked configuration, the electronic display 301 may display information that is specific to the key received by the lock assembly 100.

FIG. 4 shows a schematic for a passive lock assembly 100, according to an embodiment of the present disclosure, where the locking device 109 is a sensor 401. In addition to the sensor 401, the lock assembly 100 may have a transmitter 402. In this embodiment, when the switch signal switches the lock assembly 100 to an unlocked configuration, the processing unit 104 may obtain data that is collected by the sensor 401 and may then send part or all the data to the transmitter 402 for transmission to the mobile device 107. The sensor 401 may, for example, be a light sensor, a chemical sensor, a water sensor, a rust sensor, a biosensor, a motion sensor, a proximity sensor, a salinity sensor, an environmental sensor, an accelerometer, a flow sensor, a pressure sensor, or a thermometer. In one example implementation, the sensor 401 may detect cracks in a concrete structure by collecting data on structural movements of the concrete structure. The transmitter 402 may transmit the data to the mobile device 107 through a wireless channel 403, which may, for example, be a wireless radio communication channel such as a Bluetooth channel or an optical channel that communicates by light.

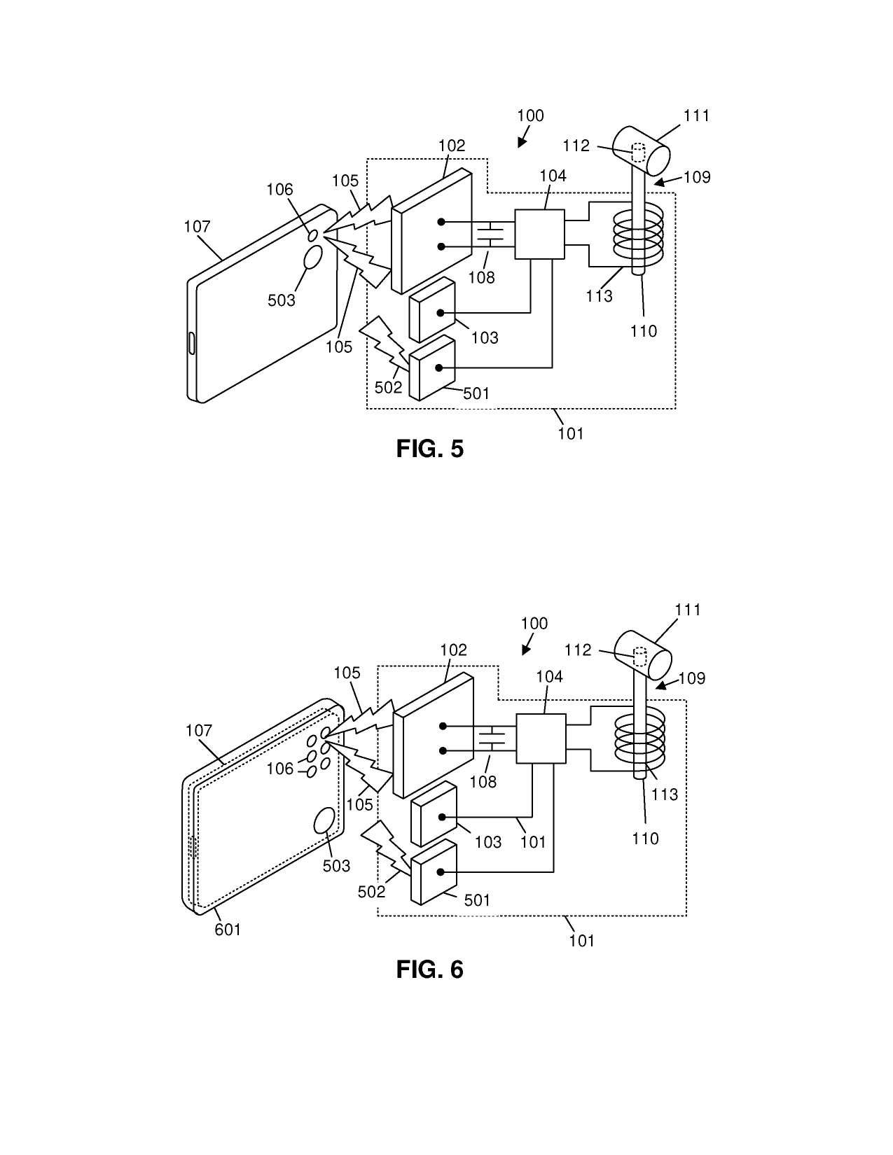

FIG. 5 shows a schematic for a passive lock assembly 100, according to an embodiment of the present disclosure, that has a lock light source 501 configured to emit light 502 encoding a lock identifier. The lock light source 501 may, for example, be one of or a plurality of light emitting diodes, display screens, or lasers. The light 502 emitted by the lock light source 501 may have associated thereto a spectrum of wavelengths that is broad or narrow. For example, the light 502 may be a white light or a monochromatic light. Wavelengths associated with the light 502 may, for example, belong to ultraviolet, visible, or infrared regions. The lock identifier may be encoded in the light 502 by, for example, temporally and/or spatially modulating the intensity and/or frequency of the light 502. The light 502 may be emitted once power is supplied to the lock light source 501 by the electrical signal generated at the optical-to-electrical converter device 102. The light 502 may be received by the mobile device 107 through, for example, a camera 503 of the mobile device 107. The mobile device 107 may then process the light 502 received to obtain the lock identifier. With the lock identifier, the mobile device 107 may generate or obtain a key (e.g., stored on the mobile device 107 on in a database accessible by the mobile device 107) corresponding to the lock assembly 100.

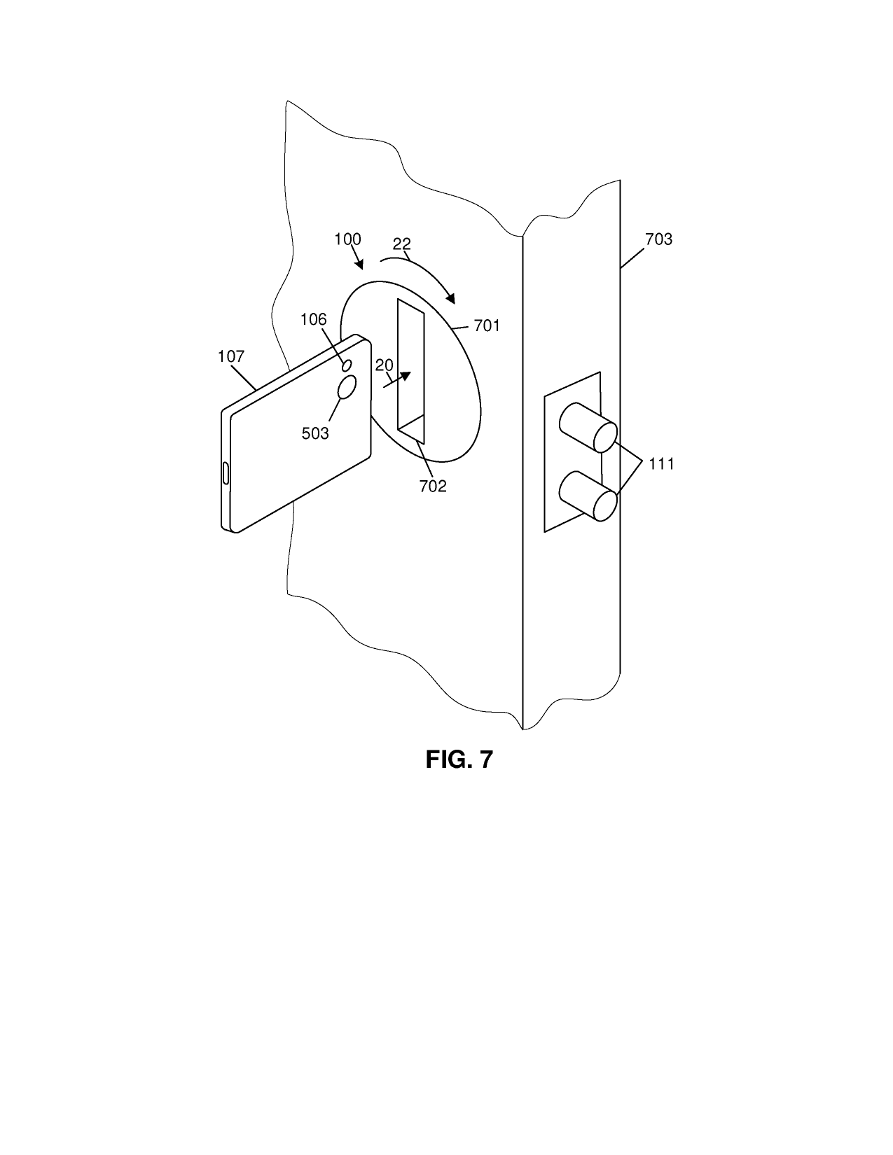

FIG. 6 shows a schematic for a passive lock assembly 100, according to an embodiment of the present disclosure, where the light 105 encoding a key may be generated by a case 601 (or “casing”) belonging to the mobile device 107. The case 601 may have one or more light sources 106. Each light source 106 may, for example, be a light emitting diode or a laser. The case 601 may further have a camera 503 to receive light 502 with a lock identifier from a lock light source 501. The case 601 may interface with the mobile device 107 to process the lock identifier and generate a key.

FIG. 7 shows an embodiment of a lock assembly 100 according to an embodiment of the present disclosure. In this embodiment, the lock assembly 100 may comprise, as a locking device, an electromechanical lock. An example of the electromechanical lock is shown at reference sign 109 in FIGS. 1, 2 and 6. The lock assembly 100 shown in FIG. 7 may have a housing 701 that defines a recess 702 configured to receive the mobile device 107. That is, the mobile device 107 may be inserted into the recess 702. The housing 701 may, for example, be built into a door 703. The recess 702 may, for example, be of a slot shape, as depicted in FIG. 7, but may be of other shapes. In the present embodiment, when the mobile device 107 is inserted into the recess 702 along the straight arrow 20 and moved according to a predetermined movement (e.g., rotated in accordance with the rotation direction indicate by the curved arrow 22), the movement may actuate a latch mechanism associated with (coupled to) the electromechanical lock. In some embodiments, the latch mechanism may include a latch or a bolt as shown at reference sign 111 in FIGS. 1, 2 and 6. The housing 701 may be configured to move in agreement with the movement of the mobile device 107.

When the lock assembly 100 is in the locked configuration, the electromechanical lock may hold the latch mechanism, preventing its actuation by movement of the mobile device 107. When the lock assembly 100 is in the unlocked configuration, the electromechanical lock may release the latch mechanism, permitting its actuation by movement of the mobile device 107. The recess 702 may have located therein a optical-to-electrical converter device and a key reader (e.g., the optical-to-electrical converter device 102 and the key reader 103 shown in FIG.1). In addition, the recess 702 may have located therein a transmitter (e.g., the transmitter 402 shown in FIG. 4) and/or a lock light source (e.g., the lock light source 501 shown in FIG. 6). The movement may, for example, be a rotation of the phone. Actuation of the latch mechanism may, for example, cause a bolt 111 or latch to retract from a strike plate.

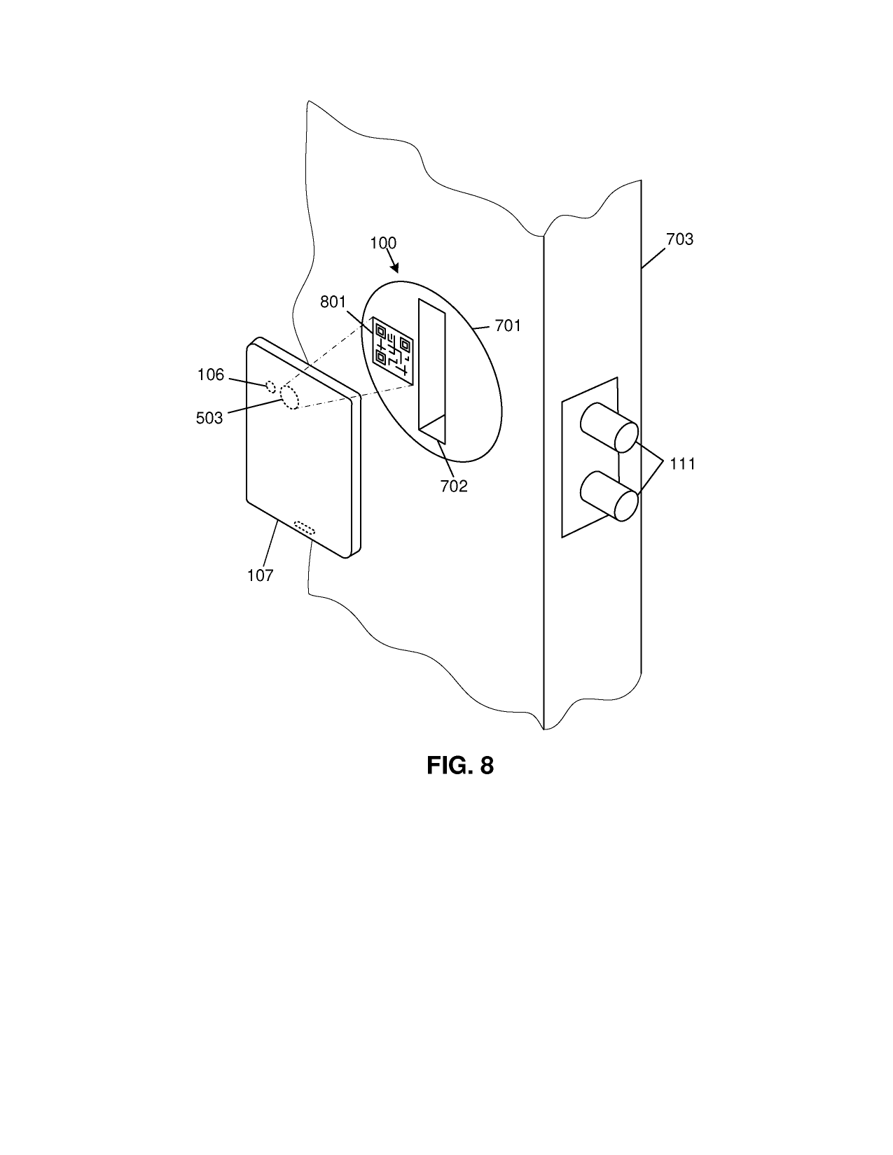

FIG. 8 shows a passive lock assembly 100, according to an embodiment of the present disclosure, where the housing 701 has a lock identifier 801 on its surface. The lock identifier 801 may be located on an exterior surface of the housing 701 or on a surface of the recess 702. The lock identifier 801 may be a visual element such as a barcode, a number, a pattern, an alphanumeric code, or an image. In some embodiments, the image may be a barcode or a QR code. The lock identifier 801 may, for example, be printed or painted on an external, visible portion of the housing 701, engraved or etched in the housing 701, displayed by an electronic paper display 701, or stamped on the housing 701. The lock identifier 801 may be configured to be read by a camera 503 belonging to the mobile device 107 and may be used to generate or find a key corresponding to the lock assembly 100.

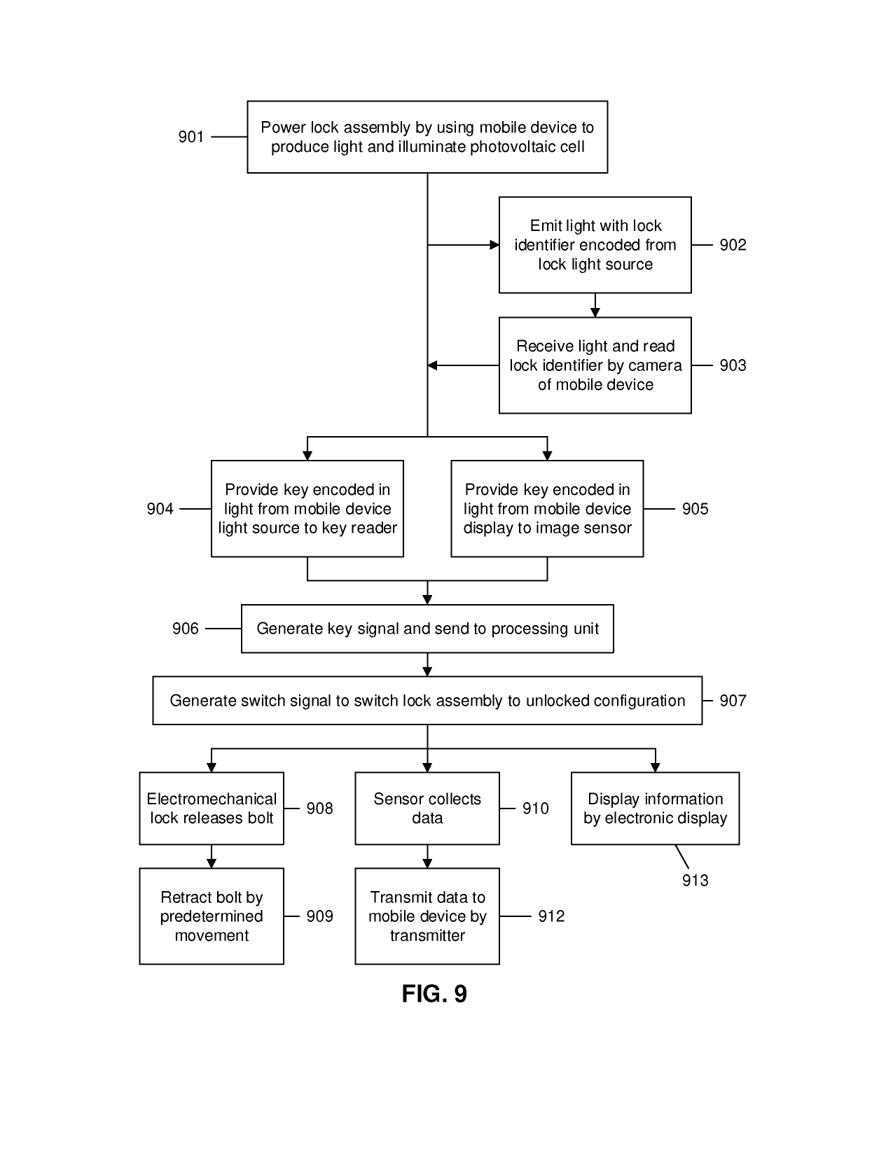

FIG. 9 shows a flowchart of an embodiment of a method for unlocking passive lock assemblies (e.g., the lock assembly 100 shown at FIGS. 1 to 8), according to the present disclosure. The method used to unlock a particular lock assembly may depend on the specific components belonging to the lock assembly. At action 901 power may be delivered to the lock assembly by producing light by a mobile device and illuminating an optical-to-electrical converter device of the lock assembly. The light may alternatively be produced by a case coupled to (belonging to) the mobile device. If the lock assembly has a lock light source, the lock light source may emit light with a lock identifier encoded in it, at action 902. A camera belonging to the mobile device, or to a case of the mobile device, may be used, at action 903, to receive the light encoded with the lock identifier and read the lock identifier. The mobile device may then be used to determine a key, possibly in accordance with the lock identifier, and provide the key to the lock assembly by encoding it in light. The mobile device may, at action 904, provide the key to a key reader of the lock assembly by encoding the key in light from a light source of the mobile device, such as a flashlight, or the mobile device may, at action 905, provide the key to an image sensor of the lock assembly by encoding the key in light from a display of the mobile device. At action 906, the key reader (or image sensor) may generate a key signal and send it to a processing unit. At action 907, the processing unit 104 may generate a switch signal to switch the lock assembly to an unlocked configuration. Operation of the lock assembly in the unlocked configuration may vary for different embodiments. If the lock assembly has an electromechanical lock, the switch signal may cause the electromechanical lock to release a bolt or a latch, at action 908. The bolt or latch may then be retracted, such as from a strike plate belonging to a doorway, by moving a handle or the mobile device according to a predetermined movement, at action 909. If the lock assembly has a sensor and a transmitter, the switch signal may cause the sensor to collect data, at action 910. The data collected by the sensor may then be obtained by the transmitter and sent to the mobile device through a wireless channel. If the lock assembly has an electronic display, the switch signal may cause the electronic display to display information such as an image, text, or video. The methods shown in FIG. 9 may similarly be used to lock passive lock assemblies.

Embodiments of the present disclosure may be implemented using electronics hardware, software, or a combination thereof. Some embodiments may be implemented by one or multiple computer processors executing program instructions stored in memory. Some embodiments may be implemented partially or fully in hardware, for example, using one or more field programmable gate arrays (FPGAs) or application specific integrated circuits (ASICs) to rapidly perform processing operations.

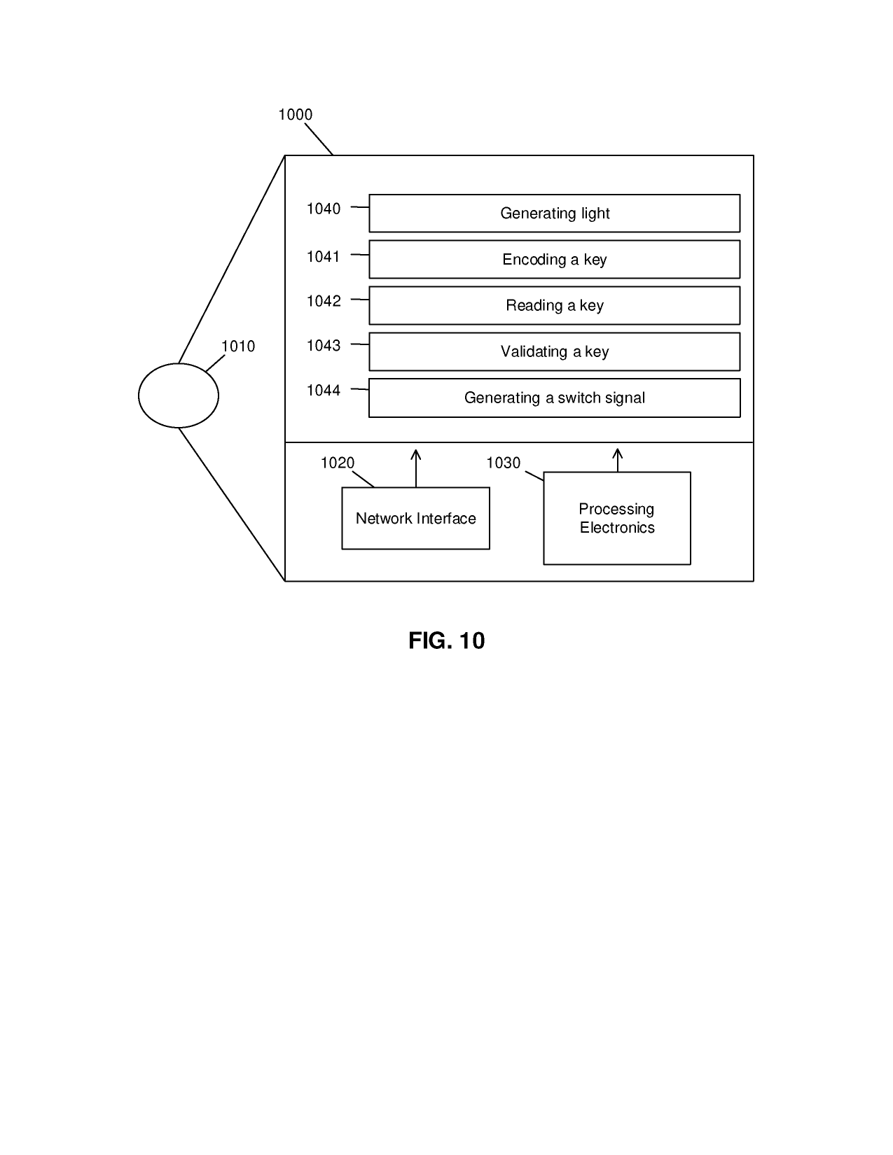

FIG. 10 shows an apparatus 1000 for implementing, at least partly, methods for unlocking a passive lock assembly according to embodiments of the present disclosure. The apparatus 1000 may, for example, be a passive lock assembly (e.g., the lock assembly 100 shown at FIGS. 1 to 8) or a mobile device (e.g., the mobile device 107 shown at FIGS. 1 to 8). The apparatus may include a network interface 1010 and processing electronics 1020. The processing electronics 1020 may include a computer processer executing program instructions stored in memory, or other electronics components such as digital circuitry, including, for example, FPGAs and ASICs. The processing electronics 1020 may, for example, be a processing unit of a passive lock assembly (e.g., the processing unit 104 shown at FIGS. 1 to 6). The network interface 1010 may include an optical communication interface or radio communication interface, such as a transmitter (e.g., the transmitter 402 shown at FIG. 4) and receiver. The apparatus 1000 may include several functional components, each of which may be partially or fully implemented using the underlying network interface 1010 and processing electronics 1020. Examples of functional components may include modules for prompting 1030 light emission, encoding 1031 a key, reading 1032 a key, validating 1033 a key, and generating 1034 a switch signal.

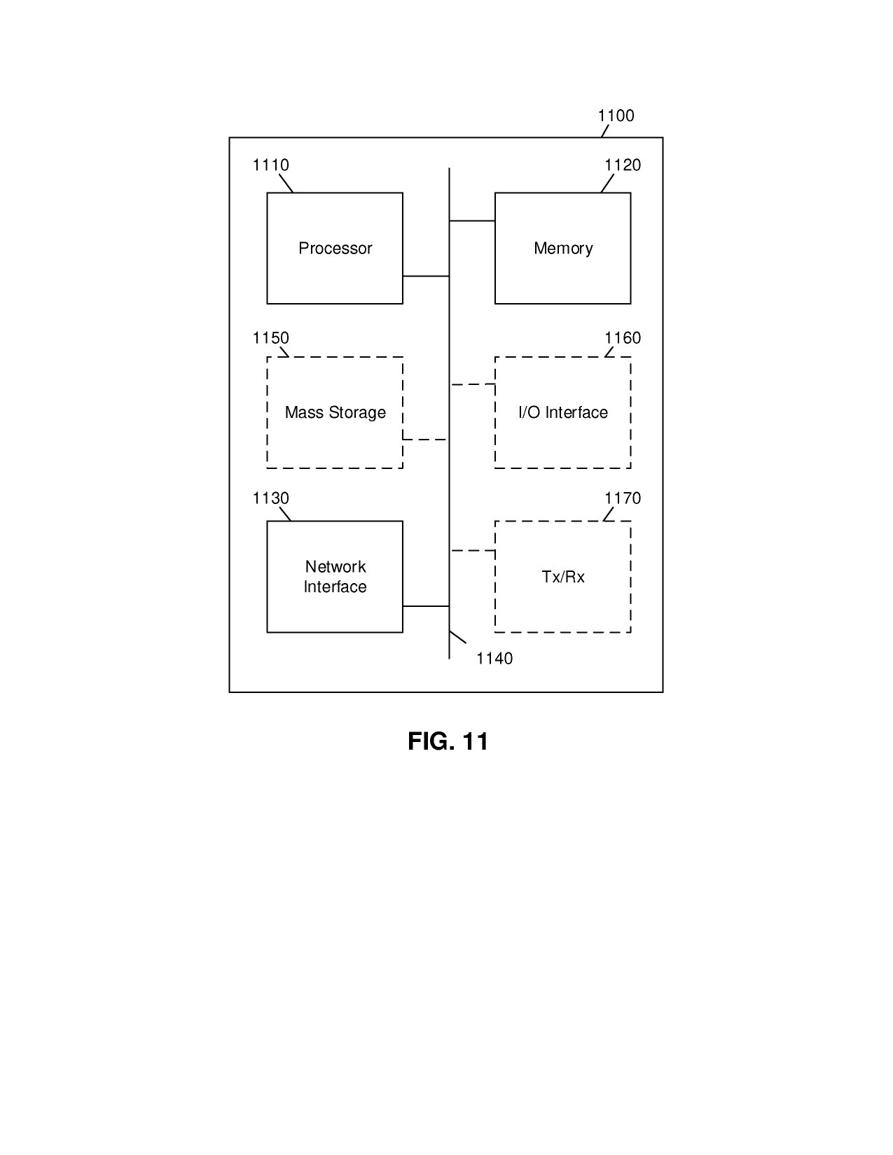

FIG. 11 is a schematic diagram of an electronic device 1100 that may perform any or all of the operations of the above methods and features explicitly or implicitly described herein, according to different embodiments of the present disclosure. For example, a mobile device, such as the mobile device 107 shown at FIGS. 1 to 8, may be configured as electronic device 1100. In addition, the electronic device 1100 may be used as part of a passive lock assembly, such as the lock assembly 100 shown at FIGS. 1 to 8.

As shown, the device may include a processor 1110, such as a Central Processing Unit (CPU) or specialized processors such as a Graphics Processing Unit (GPU) or a microprocessor other such processor unit, memory 1120, and a bi-directional bus 1130 to communicatively couple the components of electronic device 1100. Electronic device 1100 may also optionally include a network interface 1140, non-transitory mass storage 1150, an I/O interface 1160, and a transceiver 1170. According to certain embodiments, any or all of the depicted elements may be utilized, or only a subset of the elements. Furthermore, the device 1100 may contain multiple instances of certain elements, such as multiple processors, memories, or transceivers. In addition, elements of the hardware device may be directly coupled to other elements without the bi-directional bus 1130. Additionally or alternatively to a processor 1110 and memory 1120, other electronics, such as integrated circuits, may be employed for performing the required logical operations.

The memory 1120 may include any type of non-transitory memory such as static random access memory (SRAM), dynamic random access memory (DRAM), synchronous DRAM (SDRAM), read-only memory (ROM), any combination of such, or the like. Memory 1120 may include more than one type of memory, such as ROM for use at boot-up, and DRAM for program and data storage for use while executing programs. The mass storage element 1150 may include any type of non-transitory storage device, such as a solid state drive, hard disk drive, a magnetic disk drive, an optical disk drive, USB drive, or any computer program product configured to store data and machine executable program code. According to certain embodiments, the memory 1120 or mass storage 1150 may have recorded thereon statements and instructions executable by the processor 1110 for performing any of the aforementioned method operations described above. In addition, the memory 1120 or mass storage 1150 may, for example, be used by a passive lock assembly (e.g., the lock assembly 100 shown at FIGS. 1 to 8) to store a library of valid keys or to store information to be displayed when the lock assembly is unlocked (e.g., by the electronic display 301 shown at FIG. 3). The memory 1120 or mass storage 1150 may, as another example, be used by a mobile device (e.g., the mobile device 107 shown at FIGS. 1 to 8) to store a library of keys that each correspond to a different lock assembly to receive data transmitted by a transmitter of a lock assembly. In some embodiments, mass storage 1150 may be remote to the electronic device 1100 and accessible through use of a network interface such as interface 1140. In the embodiment of FIG. 11, mass storage 1150 is distinct from memory 1120 and may generally perform storage tasks compatible with higher latency but may generally provide lesser or no volatility. In some embodiments, mass storage 1150 may be integrated with the memory 1120.

The bi-directional bus 1130 may be one or more of any type of several bus architectures, including a memory bus or memory controller, a peripheral bus, or a video bus.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein may be implemented as coded instructions in a computer program product. In other words, the computer program product may be a computer-readable medium upon which software code may be recorded to execute the method when the computer program product is loaded into memory and executed on processing electronics of a mobile device or a passive lock assembly.

Further, each operation of the method may be executed on any computing device, such as a mobile device (e.g., the mobile device 107 shown at FIGS. 1 to 8) or smart lock (e.g., the passive lock assembly 100 shown at FIGS. 1 to 8), or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Embodiments of the present disclosure may be implemented by using hardware only or by using software and a necessary universal hardware platform. Based on such understandings, the technical solution of the present disclosure may be embodied in the form of a software product. The software product may be stored in a non-volatile or non-transitory storage medium, which may be a compact disk read-only memory (CD-ROM), USB flash disk, or a removable hard disk. The software product includes a number of instructions that enable a computer device (mobile device, personal computer, smart lock) to execute the methods provided in the embodiments of the present invention. For example, such an execution may correspond to a simulation of the logical operations as described herein. The software product may additionally or alternatively include a number of instructions that enable a computer device to execute operations for configuring or programming a digital logic apparatus in accordance with embodiments of the present disclosure.

Although a combination of features is shown in the illustrated embodiments, not all of them need to be combined to realize the benefits of various embodiments of this disclosure. In other words, an apparatus or method designed according to an embodiment of this disclosure will not necessarily include all of the features shown in any one of the Figures or all of the portions schematically shown in the Figures. Moreover, selected features of one example embodiment may be combined with selected features of other example embodiments.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A lock assembly comprising:
circuitry comprising:
an optical-to-electrical converter device configured to generate an electrical signal when illuminated by light produced by a mobile device;
a key reader configured to be powered by the electrical signal and, when powered, to read a key encoded in the light and to generate a key signal in accordance with the key;
and
a processor configured to be powered by the electrical signal and, when powered, receive the key signal and determine a validity of the key in accordance with the key signal, the processor further configured to, when powered and the key is valid, generate a switch signal;
and
a locking device coupled to the circuitry and configured to be powered by the electrical signal, the locking device configured to switch between a locked configuration and an unlocked configuration, the locking device further configured to, when powered, receive the switch signal and, when the switch signal is received, switch from the locked configuration to the unlocked configuration.

2. The lock assembly of claim 1, further comprising a housing defining a recess configured to receive the mobile device.

3. The lock assembly of claim 2, wherein the optical-to-electrical converter device and the key reader are located in the recess.

4. The lock assembly of claim 2, wherein:
the lock assembly further comprises a latch mechanism configured to be actuated by a predetermined movement of the mobile device when the mobile device is in the recess; and
the locking device is an electromechanical lock configured to hold the latch mechanism when in the locked configuration and to release the latch mechanism when in the unlocked configuration.

5. The lock assembly of claim 1, wherein:
the lock assembly further comprises a latch mechanism to be actuated by a predetermined movement of a handle mechanically coupled to the latch mechanism; and
the locking device is an electromechanical lock configured to hold the latch mechanism when in the locked configuration and to release the latch mechanism when in the unlocked configuration.

6. The lock assembly of claim 1, wherein the locking device is an electromechanical lock having a bolt configured to be in an extended position when in the locked configuration and to be in a retracted position when in the unlocked configuration.

7. The lock assembly of claim 1, wherein the locking device has a sensor coupled to a transmitter, the sensor configured to, when powered, collect data, the transmitter configured to, when powered and in the unlocked configuration, obtain the data collected from the sensor and send the data to the mobile device.

8. The lock assembly of claim 1, wherein:
the circuitry comprises a memory configured to store data thereon; and
the locking device is an electronic display configured to, when powered and in the unlocked configuration, obtain the data stored on the memory and display the data.

9. The lock assembly of claim 1, wherein the processor is further configured to, when the key is valid, generate another switch signal to switch the lock assembly from the unlocked configuration to the locked configuration.

10. The lock assembly of claim 1, wherein the key is encoded in the light produced by the mobile device as one or more of: one or more changes in one or more optical properties of the light over a period of time, or a spatial pattern of at least one of light intensity and color.

11. The lock assembly of claim 10, wherein the one or more optical properties of the light include at least one of a polarization of the light, a phase of the light, a frequency of the light, and an intensity of the light.

12. The lock assembly of claim 10, wherein the key reader includes a photodetector or the key reader is an image sensor.

13. The lock assembly of claim 4, wherein the circuitry includes one or more of: a solenoid or a motor to switch the electromechanical lock between the locked configuration and the unlocked configuration.

14. The lock assembly of claim 7, wherein the transmitter sends the data to the mobile device through one or more of: wireless radio communication or light.

15. The lock assembly of claim 1, further comprising:
a lock light source configured to be powered by the electrical signal and, when powered, emit light encoded with a lock identifier.

16. A method of unlocking a lock assembly, the method comprising:
producing, by a mobile device, light; and
encoding, by the mobile device, a key in the light produced by the mobile device, wherein the lock assembly comprises circuitry comprising:
an optical-to-electrical converter device configured to generate an electrical signal when illuminated by the light produced by the mobile device;
a key reader configured to be powered by the electrical signal and, when powered, to read the key encoded in the light and to generate a key signal in accordance with the key;
and
a processor configured to be powered by the electrical signal and, when powered, receive the key signal and determine a validity of the key in accordance with the key signal, the processor further configured to, when powered and the key is valid, generate a switch signal;
and
a locking device coupled to the circuitry and configured to be powered by the electrical signal, the locking device configured to switch between a locked configuration and an unlocked configuration, the locking device further configured to, when powered, receive the switch signal and, when the switch signal is received, switch from the locked configuration to the unlocked configuration.

17. The method of claim 16, the method comprising:
reading, by the mobile device, a lock identifier;
determining, by the mobile device, the key according to the lock identifier;
producing, by the mobile device, the light; and
encoding, by the mobile device, the key in the light produced by the mobile device.

18. The method of claim 16, the method comprising:
producing, by the mobile device, the light;
receiving, by the mobile device, the light encoded with a lock identifier;
determining, by the mobile device, the key according to the lock identifier; and
encoding, by the mobile device, the key in the light produced by the mobile device.

19. The method of claim 16, the method comprising:
inserting the mobile device into a housing;
producing, by the mobile device, the light;
encoding, by the mobile device, the key in the light produced by the mobile device; and
moving the mobile device according to a predetermined movement.

20. The method of claim 16, the method comprising:
producing, by one or more light sources of a casing of the mobile device, the light; and
encoding, by the one or more light sources of the casing of the mobile device, the key in the light produced by the one or more light sources of the casing of the mobile device.
